(19) United States
(12) Patent Application Publication
(10) Pub. No.: US 2017/0344711 A1
(43) Pub. Date: Nov. 30, 2017

(54) SYSTEM AND METHOD FOR PROCESSING MEDICAL QUERIES USING AUTOMATIC QUESTION AND ANSWERING DIAGNOSIS SYSTEM

(71) Applicant: Baidu USA LLC, Sunnyvale, CA (US)

(72) Inventors: Bocong Liu, Sunnyvale, CA (US); Yu Cao, Santa Clara, CA (US); Richard Wang, Sunnyvale, CA (US)

(21) Appl. No.: 15/169,470

(22) Filed: May 31, 2016

(51) Int. Cl. G06F 19/00; G06N 5/02

(52) U.S. Cl. CPC G06F 19/345; G06F 19/326; G06N 5/022

(57) ABSTRACT

In response to receiving a user inquiry describing one more symptoms of a medical condition, an online medical diagnosis system can determine one or more medical conditions related to the one or more symptoms. The online medical diagnosis system can include a parser to parse the user inquiry into keywords. The keywords can be looked up in a correlation graph model to determine a correlation of the keywords to one or more expert keywords. Keywords meeting a threshold correlation to expert keywords can be used to look up one or more medical conditions using an expert knowledge graph model. A user profile can be used to modify correlation values of keywords to expert keywords. The user profile can also be used to narrow the number medical conditions returned by the expert knowledge graph model. A medical resources crawler can use keywords parsed from stored user inquiries, and expert keywords, to update the correlation graph model.

### FIELD OF THE INVENTION

Embodiments of the present invention relate generally to medical diagnosis. More particularly, embodiments of the invention relate to automated online medical diagnosis.

### BACKGROUND

Online medical diagnosis systems try to understand a user's medical-related queries such that the system can behave like a doctor as much as possible. An online medical diagnosis system must have precision and recall. However, in existing machine-learning systems, there is often an inverse relationship between precision and recall where it is possible to increase one at the cost of the other.

Existing medical online diagnosis systems use a single model, such as a deep learning model, to understand a user's query and to predict a medical condition. However, due to lack of training data, especially for diagnosis, deep learning models usually cannot achieve a good result.

### BRIEF DESCRIPTION OF THE DRAWINGS

Embodiments of the invention are illustrated by way of example and not limitation in the figures of the accompanying drawings in which like references indicate similar elements.

FIG. 1A is a block diagram illustrating an example of an online medical diagnosis system according to an embodiment of the invention.

FIG. 1B is a block diagram illustrating an information and logic flow of an online medical diagnosis system according to an embodiment of the invention.

FIG. 1C is a block diagram illustrating an information and logic flow of a correlation graph model learning system according to an embodiment of the invention.

FIG. 2 is a block flow diagram of a method of online medical diagnosis according to one embodiment of the invention.

FIGS. 3A and 3B are a block flow diagram of a method of online medical diagnosis according to one embodiment of the invention.

FIG. 4 is a diagram illustrating two examples of a user profile for use in a method of online medical diagnosis according to one embodiment of the invention.

FIG. 5 is a block flow diagram of a method of training a correlation graph model according to one embodiment of the invention.

FIG. 6 is a block diagram illustrating a data processing system according to one embodiment.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, a computer-implemented method for automating medical diagnosis can received from an electronic device of a user, a user medical query comprising one or more symptoms. The automated medical diagnosis systems includes two major subsystems: a correlation graph model that correlates user-entered terms or keywords to expert keywords that are understood by an expert knowledge graph model, with a correlation factor.

The correlation graph model can be dynamically constructed from user-entered queries and reflects the weighted relations among arbitrary medical related words, phrases, and sentences and entities in the expert knowledge graph model. For example, “my baby has high body temperature” will be mapped to “fever” with a score of 0.9, “cold” with a score of 0.6, “cough” with a score of 0.5, etc. Data sources used to build the correlation graph model include the combined stored query logs of all users and crawled data from online medical resources such as medical articles, research papers, and other online medical information.

The expert knowledge graph model is composed of real doctors' knowledge. For example, “cold” can cause “fever” with 70% probability, “stuff nose” with 90% probability, and “cough” with 50% probability. By using a graph model to represent the expert knowledge, the decision model is easily scalable and can easily integrate new doctor knowledge. The expert knowledge graph model uses the results from the correlation graph model to predict a response to a user's query with high accuracy and quality. The recall of the medical diagnosis system can be tuned by dynamically updating of the correlation graph model. The expert knowledge graph model is relatively static and can be updated manually by medical professionals, such as doctors, as needed.

The correlation graph model focuses on coverage, using dynamic learning. The expert knowledge graph model focuses on accuracy. The overall system, combining the output of the correlation graph model with the expert knowledge graph model, performs better than a single deep-learning model.

A user medical query can be parsed into one or more keywords representing symptoms of a medical condition. The one or more keywords can be correlated to one or more expert keywords using a correlation graph model. One or more medical conditions can be determined based upon the one or more expert keywords using an expert knowledge graph model. The determination of one or more medical conditions can each have a confidence level that is distinct from the correlation weight of keywords to expert keywords. In an embodiment, the correlation graph model is dynamically updated, and the expert knowledge graph model is static. One or more of the keywords can be filtered by limiting the one or more keywords to only those keywords that meet a threshold correlation to an expert keyword. In an embodiment, in response to determining that more than one medical condition is determined using the expert knowledge graph model, the expert knowledge graph model can be used to determine one or more additional symptoms that will reduce the number of medical conditions determined by the expert knowledge graph model. A user can be prompted to answer whether the user has any of the one or more additional symptoms. In an embodiment, in response to determining that one medical condition is determined by the expert knowledge graph model, it can be determined whether the one medical condition requires treatment by a physician. If not, then the online medical diagnosis system can generate a self-care recommendation for the user. If the one or more medical conditions do require treatment by a physician, then a recommendation can be generated to a particular physician. In an embodiment, an appointment can be automatically scheduled with the recommended physician. A user profile for the user can be retrieved and used to modify the correlation weights of keywords to expert keywords. The user profile can also be used to limit or reduce the number of medical conditions returned from the expert knowledge graph model or change the confidence factor of the medical conditions.

In another embodiment, a correlation graph model (CGM) learning system can parse stored user query logs to obtain possible new keywords for inclusion in the correlation graph model. A medical resource crawler can use the keywords obtained from parsing the stored query logs to obtain more keywords and/or determine correlation of keywords to expert keywords. A learning model, such as Bayesian, naive Bayes, linear regression, random neural network, recurrent neural network, or long short term memory can be used to determine correlation weights of keywords to expert keywords. The keywords and weights can be stored in the correlation graph model.

In an embodiment, any of the above functionality can be embodied as executable instructions stored on non-transitory computer-readable medium. In an embodiment, a system can comprise at least one hardware processor coupled to a memory comprising instructions that, when executed by the at least one hardware processor, can implement any of the above functionality.

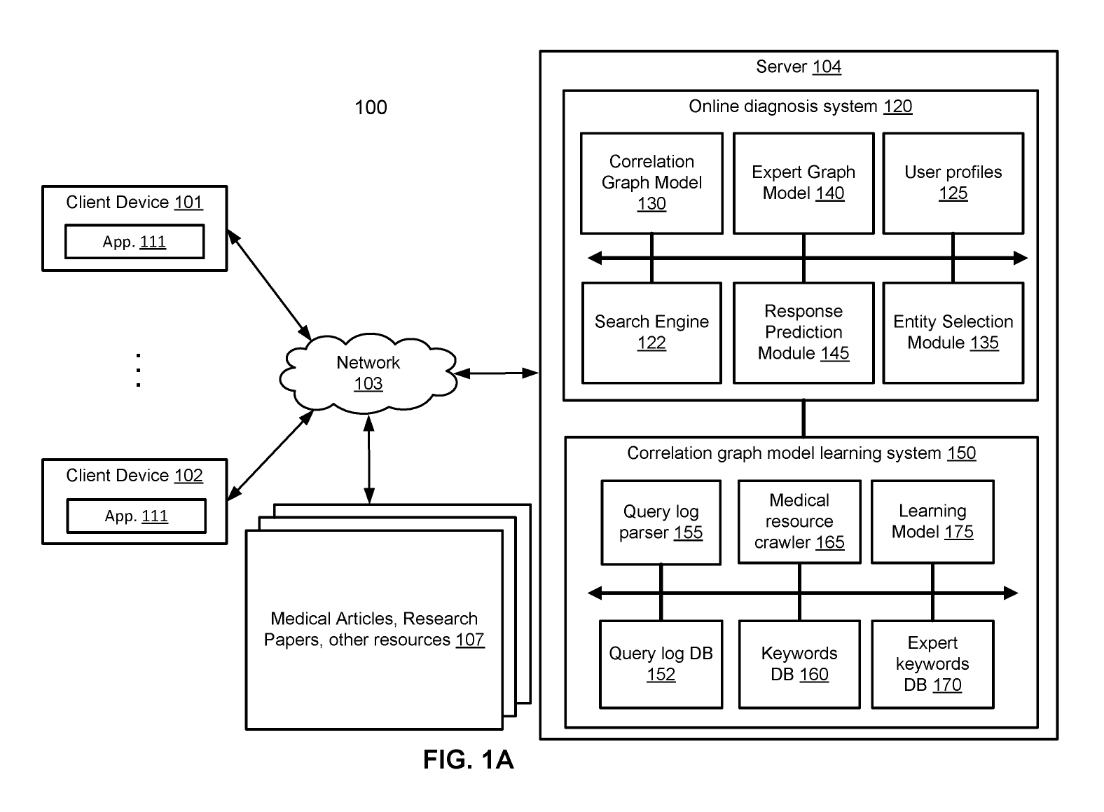

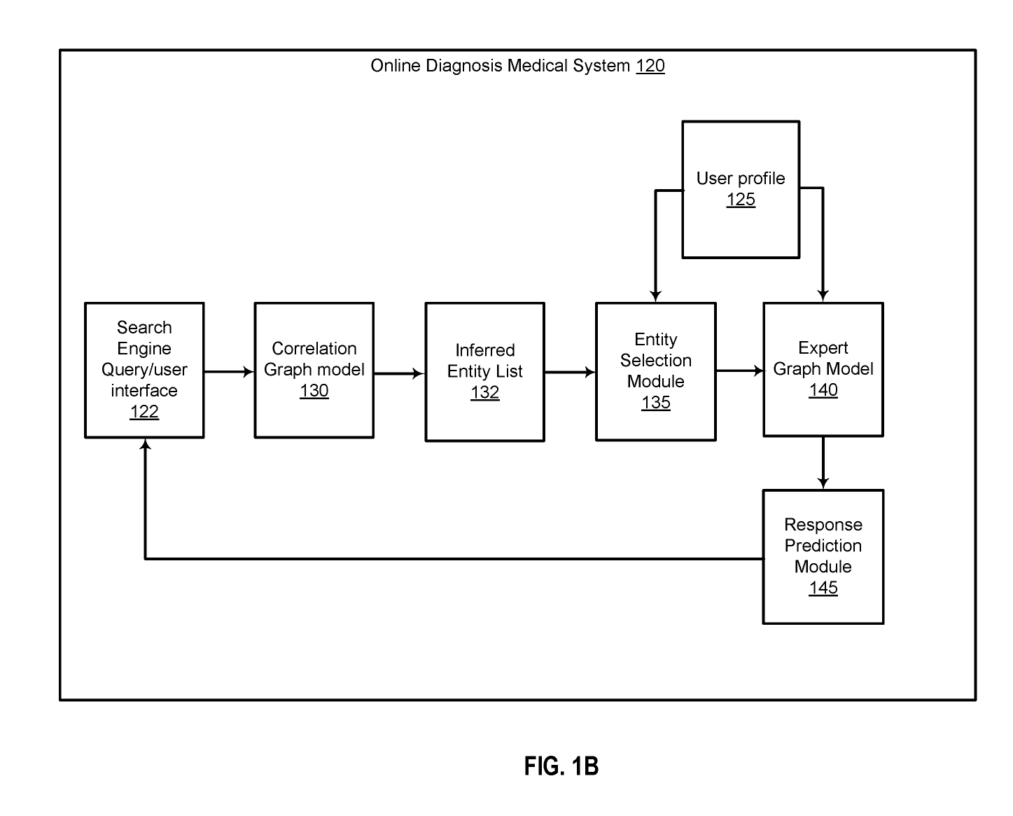

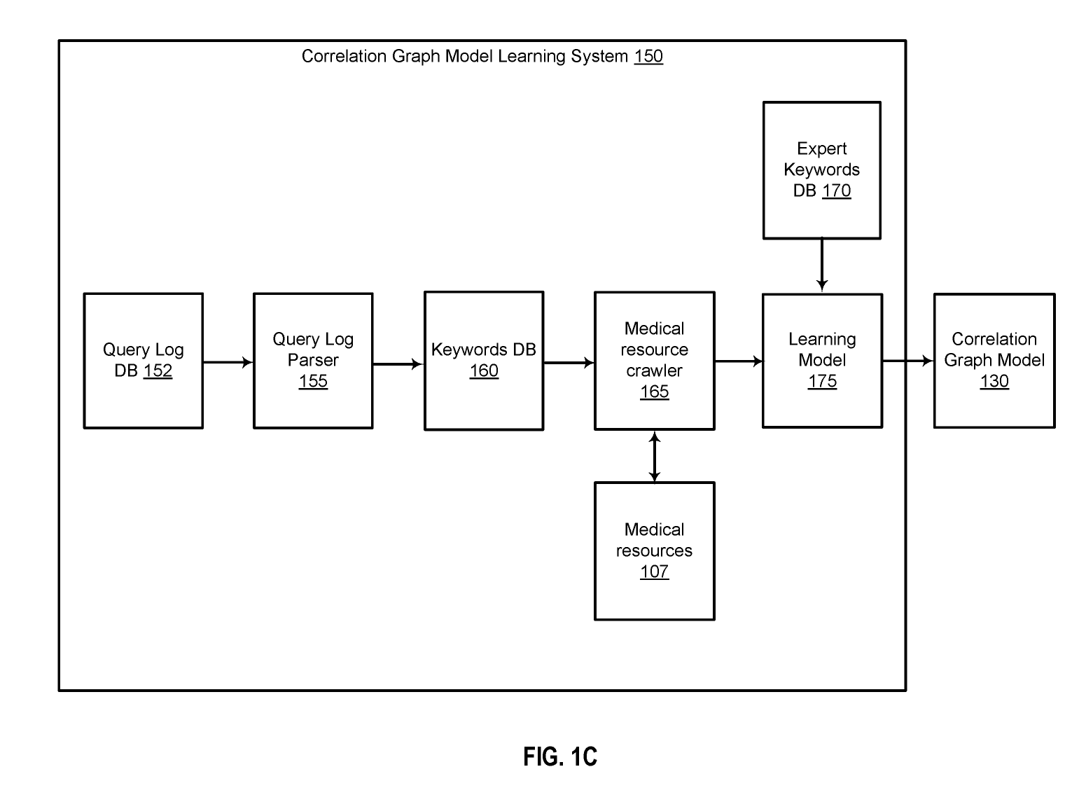

FIG. 1A is a block diagram illustrating a networked online medical diagnosis system 100 according to one embodiment of the invention. Referring to FIG. 1, system 100 includes, but is not limited to, one or more client devices 101-102 communicatively coupled to server 104 over network 103. Client devices 101-102, also referred to as user devices, may be any type of client devices such as a personal computer (e.g., desktops, laptops, and tablets), a “thin” client, a personal digital assistant (PDA), a Web enabled appliance, a Smartwatch, or a mobile phone (e.g., Smartphone), etc. Network 103 may be any type of networks such as a local area network (LAN), a wide area network (WAN) such as the Internet, or a combination thereof, wired or wireless. Client devices 101 and 102 can have one or more applications 111, such as a web browser, to facilitate interaction with server 104.

According to one embodiment, user device 101 may be associated with an end user, where user device 101 may be a mobile device (e.g., tablets), a Smartphone, a Smartwatch, or a device capable of communicate with other devices over a network 103. User device 102 may be an agent device of an agent, a person or an associate associated with a particular entity or organization, where agent device 102 may also be a mobile device (e.g., tablets), a Smartphone, a Smartwatch, or a device capable of communicate with other devices over a network. For example, an agent may be associated with a content provider of a particular content item, in this example, an auxiliary content provider providing a particular auxiliary content item (e.g., sponsored content item). For the purpose of illustration, throughout the present application, communications between a user device, an agent device, and a server will be described to illustrate the techniques of tracking user and agent interactions with content items, routing data amongst a user device, an agent device, and a server, and connecting a user of the user device with an agent of the agent device. However, it will be appreciated the techniques described throughout this application can also be applied to other scenarios.

Server 104 may be any kind of server or clusters of servers, such as Web or cloud servers, application servers, backend servers, or a combination thereof. In one embodiment, server 104 includes, but is not limited to, an online medical diagnosis system 120 and a correlation graph model learning system 150. Online medical diagnosis system 120 can include search engine 122, correlation graph model 130, entity selection module 135, expert knowledge graph model 140, response predication module 145, and user profiles 125. Server 104 further includes an interface (not shown) to allow a client such as client devices 101-102 to access resources or services provided by server 104. The interface may include a Web interface, an application programming interface (API), and/or a command line interface (CLI).

For example, a client user application 111 of user device 101, may send a search query to server 104 and the search query is received by search engine 122 via the interface over network 103. In response to the search query, search engine 122 extracts one or more keywords from the search query, the keywords representing symptoms of a medical condition as described by a user. Correlation graph model 130 can correlate the extracted one or more keywords to one or more expert keywords, the correlations having weights. An entity selection module 135 can select keywords that correlate to expert keywords above a threshold value. In an embodiment, a user profile 125 can assist the entity selection module 135 in selecting keywords by modifying the correlation weights based upon information in the user profile 125. For example, a symptom of a smoking-related medical condition, such as emphysema, may be more prevalent in a 60 year old smoker than in a 5 year old that does not live in a smoke-affected environment. Expert knowledge graph model 140 can receive the selected entities from entity selection module 135 and determine one or more medical conditions that relate to the selected entities, using a response prediction module 145. Response predication module 145 can determine one or more symptoms that may narrow the one or more medical conditions or increase, or reduce, the confidence level of a medical condition. Response prediction module 145 can prompt the user at the search engine interface 122 to provide additional symptoms. In an embodiment, response prediction module 145 can request that the user answer specific symptom questions. The above process can be repeated using the additional information provided by the user until a single medical condition can be identified or the number of medical conditions is sufficiently narrowed.

The user application 111 may be a browser application or a mobile application if the user device is a mobile device. Search engine 122 may be a Baidu® search engine available from Baidu, Inc. or alternatively, search engine 122 may represent a Google® search engine, a Microsoft Bing™ search engine, a Yahoo® search engine, or other search engine.

A search engine 122, such as a Web search engine, is a software system that is designed to search for information on the World Wide Web. The search results are generally presented in a line of results often referred as search engine results pages. The information may be a mix of Web pages, images, and other types of files. Some search engines also mine data available in databases or open directories. Unlike web directories, which are maintained only by human editors, search engines 122 also maintain real-time information by running an algorithm on a web crawler, such as medical resource crawler 165.

Web search engines 122 work by storing information about many web pages, which they retrieve from the hypertext markup language (HTML) markup of the pages. These pages are retrieved by a Web crawler 165, which is an automated Web crawler which follows every link on the site. The search engine 122 then analyzes the contents of each page to determine how it should be indexed (for example, words can be extracted from the titles, page content, headings, or special fields called meta tags). Data about web pages are stored in an index database for use in later queries. The index helps find information relating to the query as quickly as possible.

When a user enters a query into a search engine 122 (typically by using one or more keywords), the search engine 122 examines its index and provides a listing of best-matching web pages according to its criteria, usually with a short summary containing the document's title and sometimes parts of the text. The index is built from the information stored with the data and the method by which the information is indexed. The search engine 122 looks for the words or phrases exactly as entered. Some search engines 122 provide an advanced feature called proximity search, which allows users to define the distance between keywords. There is also concept-based searching where the research involves using statistical analysis on pages containing the words or phrases you search for. As well, natural language queries allow the user to type a question in the same form one would ask it to a human.

The usefulness of a search engine 122 depends on the relevance of the result set it gives back. While there may be millions of web pages that include a particular word or phrase, some pages may be more relevant, popular, or authoritative than others. Most search engines 122 employ methods to rank the results to provide the “best” results first. How a search engine 122 decides which pages are the best matches, and what order the results should be shown in, varies widely from one engine to another. Further details of online diagnosis system 120 are described below with reference to FIG. 1B.

Server 104 may include a correlation graph model (CGM) learning system 150 that can dynamically update a correlation graph model 130. A correlation graph model 130 correlates user search terms representing medical symptoms with expert keywords of an expert knowledge graph model 140 related to medical conditions. The CGM learning system 150 can parse a history or database of query logs stored from a large number of user query sessions with the online diagnosis system 120 to generate a database of keywords 160. In an embodiment, a medical resource crawler 165 can use keywords 160 and expert keywords 170 to crawl medical articles, research papers, and other medical resources 107 to determine a correlation of keywords 160 obtained from user queries to expert keywords 170 obtained from expert knowledge graph model 140. The CGM learning system 150 can use a learning model 175 such as Baysian, naive Bayes, linear regression, random neural network, recurrent neural network, or long short term memory to determine correlation weights of keywords 160 to expert keywords 170 for the correlation graph model 130. In an embodiment, the learning model 175 is an unsupervised learning model. The CGM learning system 150 can perform its dynamic learning asynchronously from the user queries of the online medical diagnosis system 120.

Network crawlers or Web crawlers, such as medical resource crawler 165, are programs that automatically traverse the network's hypertext structure. In practice, the network crawlers may run on separate computers or servers, each of which is configured to execute one or more processes or threads that download documents from URLs. The network crawlers receive the assigned URLs and download the documents at those URLs. The network crawlers may also retrieve documents that are referenced by the retrieved documents to be processed by a content processing system (not shown) and/or search engine 120. Network crawlers can use various protocols to download pages associated with URLs, such as hypertext transport protocol (HTTP) and file transfer protocol (FTP).

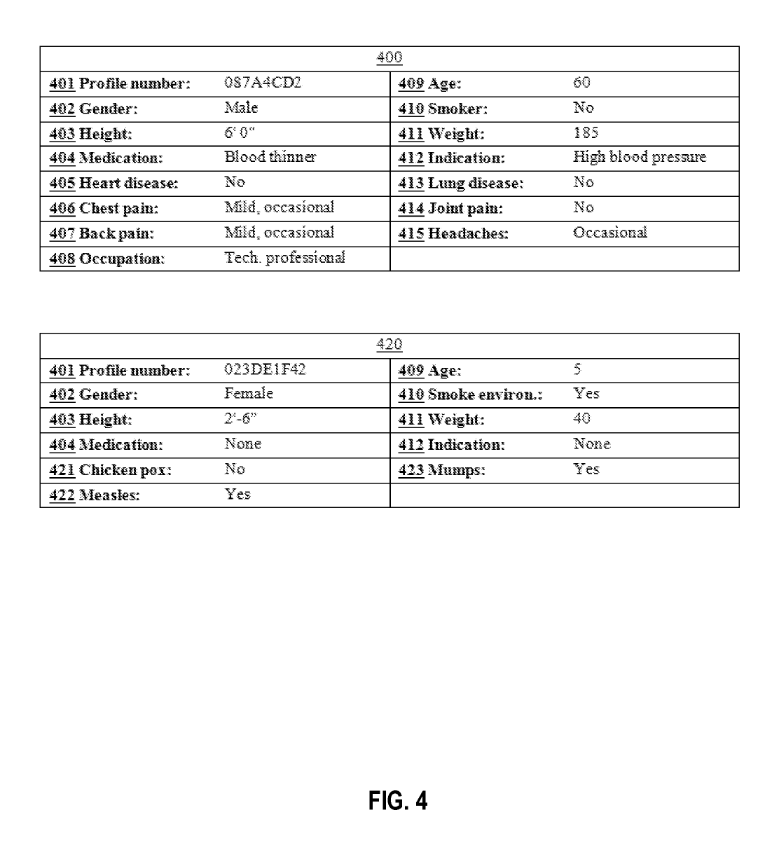

Server 104 can correlate and identify the first user further in view of the search activities associated with the first user from interaction with search engine 122 and storage of search logs in a query log database 152. The search activity information may be captured and recorded in query log database 152 when a search was performed. The server 104 can retrieve user information of the first user from query log database 152 and/or from user profile 125. The server 104 optionally can transmit at least some of the user information of the first user from the query log database 152 to the online diagnosis system 120, which may be compiled into a user profile 125. As a result, the first user can connect and communicate with the online medical diagnosis system 120 based on the user information of the first user in the user profile 125 in a more friendly and efficient manner. In an embodiment, user profile 125 can be generated by the user interacting with an online questionnaire that stores the user's responses to questions about the user's medical health. Example user profiles 125 are described with reference to FIG. 4, below. Additional details of CGM learning system 150 are described below with reference to FIG. 1C. Note that CGM learning system 150 is integrated within server 104 in this example. However, CGM learning system 150 can be implemented in a separate system or server that is communicatively coupled to server 104.

FIG. 1B is a block diagram illustrating an information and logic flow of an online medical diagnosis system 120 according to an embodiment of the invention.

A client, such as client 101, can begin using the online medical diagnosis system 120 by issuing a medical query to query/user interface of search engine 122. In an embodiment, search engine 122 can identify a user by a hardware identification of client 101 contained within the query received from the user. The hardware identification can be used to retrieve a user profile 125 for use by the online diagnosis system 120. In an embodiment, a user can log in to the online medical diagnosis system 120 and a user profile 125 can be looked up using the user login. The user's query can be parsed into one or more keywords 160. The keywords 160 can be looked up in the correlation graph model 130 to determine a weighted correlation of keywords 160 of the user query to expert keywords 170 obtained from the expert knowledge graph model 140. The correlated keywords 160 to expert keywords 170 represent one or more entities of the expert knowledge graph model 140. Entity selection model 135 can select a subset of the entities for further diagnosis. In an embodiment, the weighting factors of keywords 160 to expert keywords 170 can be modified by referring to user profile 125. For example, gender, age, previous medical conditions, and combinations of these can be used to modify the weight of keyword 160 correlation to expert keywords 170. Entity selection module 135 can select entities for analysis by expert knowledge graph model 140 based upon an entity having a minimum threshold correlation value of a keyword 160 to an expert keyword 170. For example, using the user profile 125, a smoker of age 60 may correlate the term “cough” more heavily to “emphysema” or “lung disease” than a 5 year old that does not live in a smoke-affected environment. Similarly, a 50 year old female may correlate a breast soreness or lump more heavily to breast cancer than would a 6 year old male. After adjustment of correlation weights of keywords 160 to expert keywords 170 using the user profile 125, entity selection module 135 can pass selected entities meeting a threshold correlation weight to the expert knowledge graph model 140. Expert knowledge graph model 140 can determine one or more medical conditions from the expert keywords 170 in the entities selected by entity selection module 135 with a confidence factor for each medical condition. Response prediction module 145 can determine that expert knowledge graph model 140 has returned one or more medical conditions. If expert knowledge graph model 140 returns only one medical condition, then response prediction module 145 can determine the severity of the illness and whether an appointment should be scheduled for a doctor to see the user. If expert knowledge graph model 140 returns more than one medical condition, response prediction module 145 can prompt the user to provide more symptoms that can reduce the number of results returned from response prediction module 145.

FIG. 1C is a block diagram illustrating an information and logic flow of a correlation graph model (CGM) learning system 150 according to an embodiment of the invention. CGM learning system 150 can operate asynchronously, or offline, with respect to online medical diagnosis system 120.

Each time a user accesses the online medical diagnosis system 120, the user's query can be stored in a query log database (query log DB) 152. Query logs in the query log DB 152 contain symptom keywords that a user has entered in a search query for the online medical diagnosis system 120.

Query log parser 155 can read, or query, the query log DB 152 and parse the query logs to determine keywords 160. The keywords can be stored in a keywords database (keywords DB) 160. Medical resource crawler 165 can crawl the web, accessing online medical resources 107 such as medical articles, research papers, and other online medical resources to determine other keywords that occur in the medical resources 107 in conjunction with the keywords 160 obtained from the query logs 152. Other keywords obtained from crawling medical resources 107 can include expert keywords 170. Expert keywords 170 can be obtained from expert knowledge graph model 140. A learning model 175 can be selected to correlate keywords 160 and other keywords to expert keywords 170. Learning models 175 can include Bayesian, naive Bayes, linear regression, random neural network, recurrent neural network, or long short term memory. In an embodiment, the learning model 175 can be an unsupervised learning model. Correlation of keywords 160 to expert keywords 170 can be stored in correlation graph model 130 as weights in a graph. Correlation graph model 130 can be stored as a part of CGM learning system 150, accessible by online medical diagnosis system 120. In an embodiment, correlation graph model 130 can be stored as a part of online medical diagnosis system 120, accessible by CGM learning system 150.

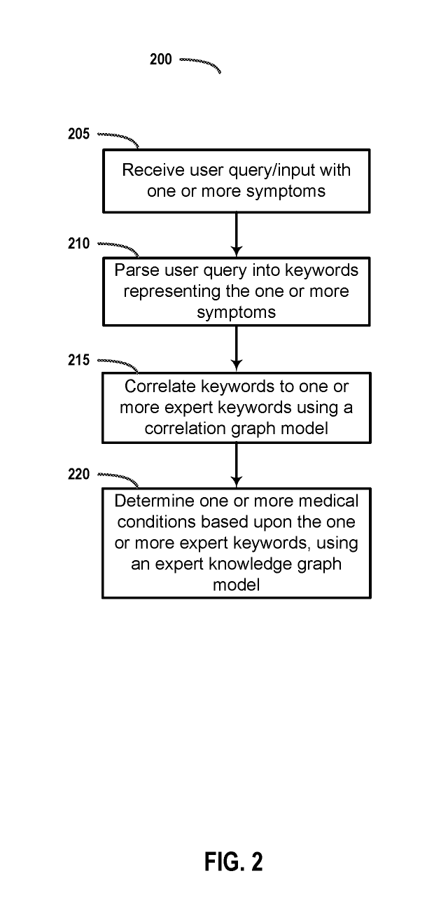

FIG. 2 is a block flow diagram of a method 200 of online medical diagnosis according to one embodiment of the invention. In operation 205, search engine query/user interface 122 of online medical diagnosis system 120 can receive a user query/input containing one or more symptoms of a medical condition. In operation 210, the search engine query/user interface 122 can parse the user query into one or more keywords 160. In operation 215, correlation graph model 130 can be used to determine a correlation weight of the one or more keywords 160 to expert keywords 170. In operation 220, expert knowledge graph model 140 can use the expert keywords and correlation weights of keywords to expert keywords to determine one more medical conditions, each having a confidence factor.

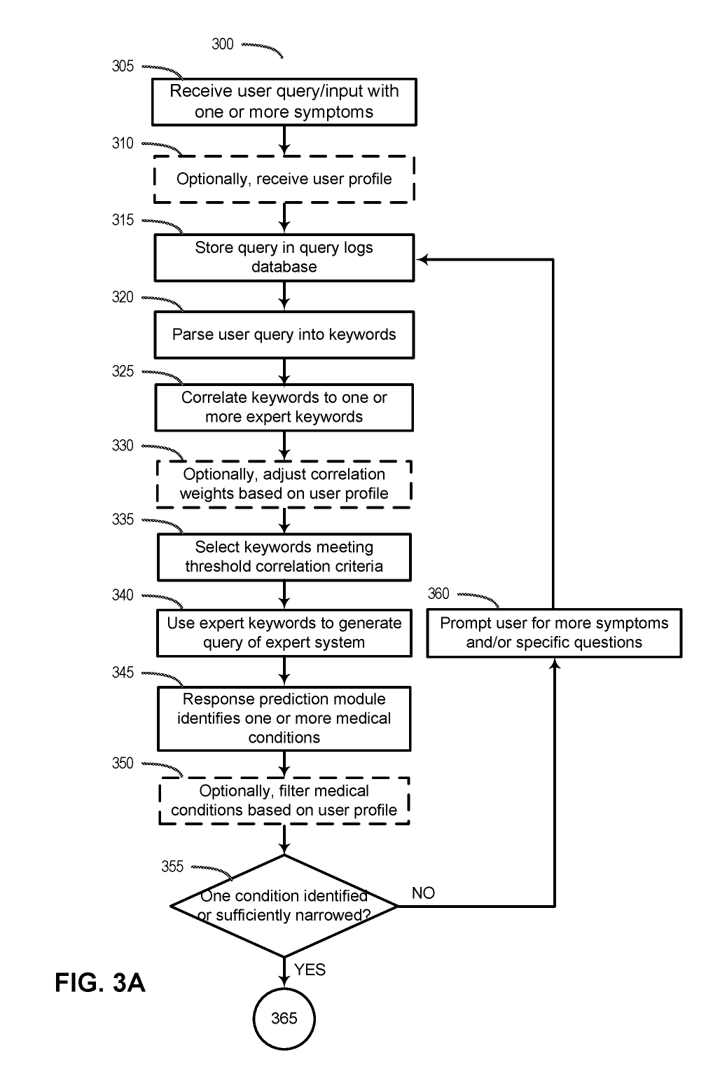

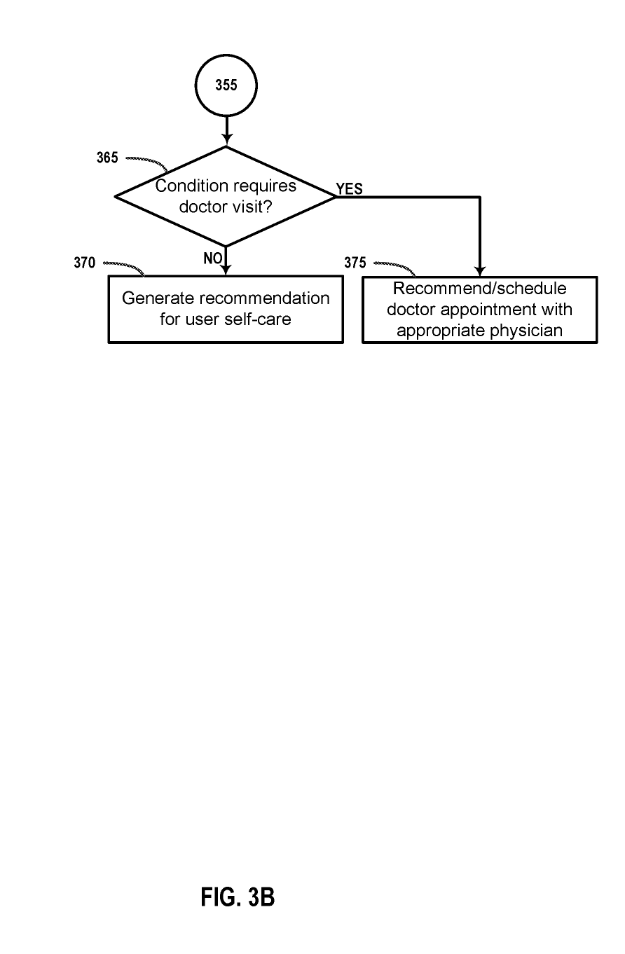

FIGS. 3A and 3B are a block flow diagram of a method 300 of online medical diagnosis according to another embodiment of the invention. In operation 305, search engine query/user interface 122 of online medical diagnosis system 120 can receive a user query/input containing one or more symptoms of a medical condition.

In operation 310, a user profile 125 can optionally be determined for the user. The user profile can be determined automatically, using an identifier such as a unique hardware identifier of the electronic device that the user is using to access the online medical diagnosis system 120. The user profile 125 can alternatively be determined by the user logging in to the online medical diagnosis system 120 and the online medical diagnosis system 120 accessing a user profile 125 associated with the user login. In an embodiment, the user can select a user profile 125 to use for the query, such as a parent selecting a user profile 125 for one of her children to whom this query relates.

In operation 315, the user query can be stored in query log database 152. In operation 320, the user query can be parsed into keywords 160 by a parser of the search engine query/user interface 122. In operation 325, the correlation graph model 130 can be used to correlate keywords 160 to one or more expert keywords 170 of the expert knowledge graph model 140, thereby determining a weight of correlation of each keyword to an expert keyword 170. Correlation of keywords 160 expert keywords 170 can generate an inferred entities list 132 of possible symptoms for analysis by expert knowledge graph model 140.

In operation 330, the correlation weights of keywords 160 to expert keywords 170 can optionally be adjusted by using the user profile 125 that relates to the query. For example, a 60 year old male with a high weight to height ratio, having a history of high blood pressure, may correlate higher to adult onset type II diabetes than a 5 year child with a normal weight to height ratio and no history of diabetes.

In operation 335, entity selection module 135 can select entities for analysis by the expert knowledge graph model 140 from the inferred entities list 132. Entity selection module 135 can select entities having a correlation weight of keyword 160 to expert keyword 170 above a predetermined threshold value. In operation 340, expert knowledge graph model 140 can use the expert keywords 170 and correlation weights of keywords 160 to expert keywords 170 to query the expert knowledge graph model 140.

In operation 345, response prediction module 145 can determine one or more medical conditions, each having a confidence value, from results returned from querying the expert knowledge graph model 140. In an embodiment, response prediction module 145 can select medical conditions returned from expert knowledge graph model 140 having a weighting or confidence factor greater than a predetermined threshold value.

In operation 350, medical conditions identified by response prediction module 145 can optionally be filtered using the user profile 125. Medical conditions can be filtered by adjusting the confidence level of a medical condition based upon the user profile 125. In an embodiment, operation 350 can be used in conjunction with operation 330 to filter entities and medical conditions using the user profile 125. In an embodiment, one or operation 330 or 350 can be used to filter entities or medical conditions, respectively.

In operation 355, it can be determined whether one medical condition has been identified by the response prediction module 145, or the medical conditions identified have been sufficiently narrowed. Response prediction module 145 may have identified a plurality of medical conditions that are closely related or have confidence factors that are too close to determine a specific one medical condition, but are sufficiently narrowed to determine a recommendation to a user.

If, in operation 355, more than one medical condition has been identified and the medical conditions are not sufficiently narrowed, then in operation 360 the response prediction module 145 can prompt the user to provide more information that will help identify a particular medical condition. In an embodiment, the user may be prompted to answer specific questions about particular symptoms that may related to the one or more medical conditions. In an embodiment, a user may be prompted to answer questions about medical history that may be related to the one or more medical conditions. In such case, the method 300 resumes at operation 315.

If, in operation 355, one medical condition is identified, or the medical conditions are otherwise sufficiently narrowed to make a recommendation to the user, then the method continues at operation 365, described below with reference to FIG. 3B.

In FIG. 3B, in operation 365, response prediction module 145 can determine whether the one or more medical conditions require a visit to a doctor for treatment. If, in operation 365, it is determined that a doctor visit is not necessary, then in operation 370 response prediction module 145 can provide a recommendation for self-care for the user. In an embodiment, the recommendation can be made to the user via the search query/user interface 122. In an embodiment, the recommendation may contain one or more links to medical resources 107 that describe recommended treatments. The recommendation may further contain one or more advertisements for medications, pharmacies, or doctors relevant to the one or more medical conditions.

If, in operation 365, it is determined that a doctor visit is necessary for treatment, in operation 375, response prediction module 145 an provide a recommended physician known to the user, or nearby to the user, for treatment. In an embodiment, the response prediction module 145 can use the search query/user interface to schedule an appointment for a particular physician for treatment.

FIG. 4 is a diagram illustrating two examples 400 and 420 of a user profile 125 for use in a method of online medical diagnosis 200 or 300 according to one embodiment of the invention. User profiles 400 and 420 can be stored in user profiles database 125.

Example user profile 400 relates to a 60 year old male. A profile number 401 can be used as a key to the user profile 400. In an embodiment, a profile number 401 can be determined from a hardware identifier of an electronic device used by the user to access the online medical diagnosis system 120. In an embodiment, the profile number 401 can be a social security number, medical insurance number, or other number assigned by a medical service provider. In an embodiment, a profile number can be randomly generated by the online medical diagnosis system 120.

A user profile can include a gender 402, a height 403, an age 409 or birth date, and a weight 411 of the user. A user profile can further indicate whether the user is a smoker 410 or lives in a smoking environment, such as a child of a parent who smokes. A user profile can further include one or more medications 404 and an indication 412 for which the medication is prescribed. A user profile 400 for an older person can include medical history for conditions such as heart disease 405, lung disease 314, chest pain 406, joint pain 414, back pain 407 and headaches 415. A user profile for an adult may indicate an occupation 408 of the user.

A user profile 420 for a child may include medical history for a youth, such as whether the child has had chicken pox 421, mumps 423, or measles 422.

The examples, above, of user profiles 400 and 420 are exemplary and not to be construed as limiting.

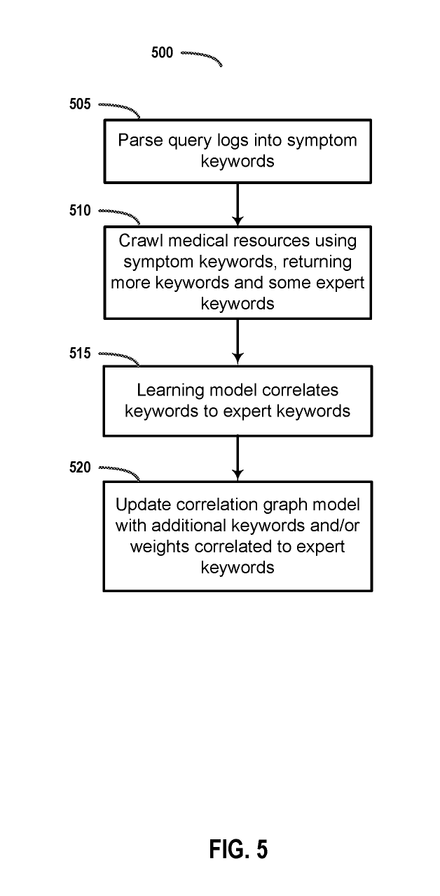

FIG. 5 is a block flow diagram of a method 500 of training a correlation graph model 130 according to one embodiment of the invention.

In operation 505, a query parser 155 can parse query logs stored in query logs database 152 into keywords 160. The keywords can be stored in keywords database 160.

In operation 510, medical resource crawler 165 can use keywords 160 to crawl medical articles, research papers, and other medical resources 107 to determine a correlation of keywords 160 obtained from user queries to expert keywords 170 obtained from expert knowledge graph model 140.

In operation 515, the CGM learning system 150 can use a learning model 175 such as Bayesian, naive Bayes, linear regression, random neural network, recurrent neural network, or long short term memory to determine correlation weights of keywords 160 to expert keywords 170 for the correlation graph model 130.

In operation 520, learning model 175 can be used to update the correlation graph model 130 with new keywords 160 and weights correlating keywords 160 to expert keywords 170. The CGM learning system 150 can perform its dynamic learning asynchronously from the user queries of the online medical diagnosis system 120.

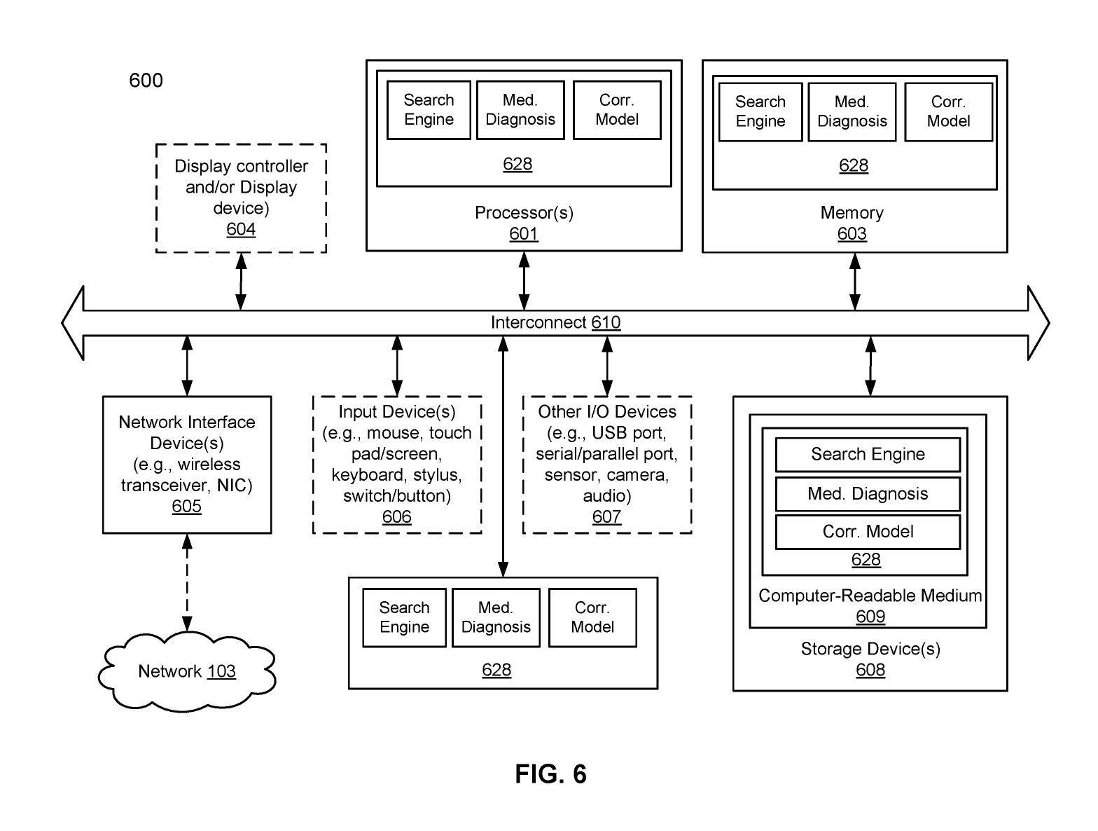

FIG. 6 is a block diagram illustrating an example of a data processing system 600 which may be used with one embodiment of the invention. For example, system 600 may represent any of data processing systems described above performing any of the processes or methods described above, such as, for example, a client device 101 or 102, or a server 104 described above.

System 600 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 600 is intended to show a high level view of many components of the computer system. However, it is to be understood that additional components may be present in certain implementations and furthermore, different arrangement of the components shown may occur in other implementations. System 600 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 600 includes processor 601, memory 603, and devices 605-608 via a bus or an interconnect 610. Processor 601 may represent a single processor or multiple processors with a single processor core or multiple processor cores included therein. Processor 601 may represent one or more general-purpose processors such as a microprocessor, a central processing unit (CPU), or the like. More particularly, processor 601 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 601 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 601, which may be a low power multi-core processor socket such as an ultra-low voltage processor, may act as a main processing unit and central hub for communication with the various components of the system. Such processor can be implemented as a system on chip (SoC). Processor 601 is configured to execute instructions for performing the operations and steps discussed herein. System 600 may further include a graphics interface that communicates with optional graphics subsystem 604, which may include a display controller, a graphics processor, and/or a display device.

Processor 601 may communicate with memory 603, which in one embodiment can be implemented via multiple memory devices to provide for a given amount of system memory. Memory 603 may include one or more volatile storage (or memory) devices such as random access memory (RAM), dynamic RAM (DRAM), synchronous DRAM (SDRAM), static RAM (SRAM), or other types of storage devices. Memory 603 may store information including sequences of instructions that are executed by processor 601, or any other device. For example, executable code and/or data of a variety of operating systems, device drivers, firmware (e.g., input output basic system or BIOS), and/or applications can be loaded in memory 603 and executed by processor 601. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 600 may further include IO devices such as devices 605-608, including network interface device(s) 605, optional input device(s) 606, and other optional IO device(s) 607. Network interface device 605 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 606 may include a mouse, a touch pad, a touch sensitive screen (which may be integrated with display device 604), a pointer device such as a stylus, and/or a keyboard (e.g., physical keyboard or a virtual keyboard displayed as part of a touch sensitive screen). For example, input device 606 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 607 may include an audio device. An audio device may include a speaker and/or a microphone to facilitate voice-enabled functions, such as voice recognition, voice replication, digital recording, and/or telephony functions. Other IO devices 607 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 607 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 610 via a sensor hub (not shown), while other devices such as a keyboard or thermal sensor may be controlled by an embedded controller (not shown), dependent upon the specific configuration or design of system 600.

To provide for persistent storage of information such as data, applications, one or more operating systems and so forth, a mass storage (not shown) may also couple to processor 601. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 601, e.g., via a serial peripheral interface (SPI). This flash device may provide for non-volatile storage of system software, including a basic input/output software (BIOS) as well as other firmware of the system.

Storage device 608 may include computer-accessible storage medium 609 (also known as a machine-readable storage medium or a computer-readable medium) on which is stored one or more sets of instructions or software (e.g., module, unit, and/or logic 628) embodying any one or more of the methodologies or functions described herein. Module/unit/logic 628 may represent any of the components described above, such as, for example, a search engine, a medical diagnosis system, or a correlation graph model learning system as described above. Module/unit/logic 628 may also reside, completely or at least partially, within memory 603 and/or within processor 601 during execution thereof by data processing system 600, memory 603 and processor 601 also constituting machine-accessible storage media. Module/unit/logic 628 may further be transmitted or received over a network via network interface device 605.

Computer-readable storage medium 609 may also be used to store the some software functionalities described above persistently. While computer-readable storage medium 609 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 628, components and other features described herein can be implemented as discrete hardware components or integrated in the functionality of hardware components such as ASICS, FPGAs, DSPs or similar devices. In addition, module/unit/logic 628 can be implemented as firmware or functional circuitry within hardware devices. Further, module/unit/logic 628 can be implemented in any combination hardware devices and software components.

Note that while system 600 is illustrated with various components of a data processing system, it is not intended to represent any particular architecture or manner of interconnecting the components; as such details are not germane to embodiments of the present invention. It will also be appreciated that network computers, handheld computers, mobile phones, servers, and/or other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for automating medical diagnosis, the method comprising:
receiving from an electronic device of a user, a user medical query comprising one or more symptoms;
parsing the user medical query into one or more keywords representing the symptoms;
correlating the one or more keywords to one or more expert keywords using a correlation graph model;
determining one or more medical conditions based upon the one or more expert keywords using an expert knowledge graph model; and
transmitting a response to the electronic device based on the one or more medical conditions.

2. The method of claim 1, wherein the correlation graph model is dynamically updated, and the expert knowledge graph model is static.

3. The method of claim 1, further comprising filtering the one or more keywords by limiting the one or more keywords to only those keywords that meet a threshold correlation to an expert keyword.

4. The method of claim 1, further comprising:
in response to determining that more than one medical condition is determined using the expert knowledge graph model:
using the expert knowledge graph model to determine one or more additional symptoms that will reduce the number of medical conditions determined by the expert knowledge graph model;
prompting the user to answer whether the user has any of the one or more additional symptoms.

5. The method of claim 1, further comprising:
in response to determining that one medical condition is determined by the expert knowledge graph model:
determining whether the one medical condition requires a treatment by a physician;
in response to determining that the one medical condition does not require treatment by a physician, generating a self-care recommendation for the user;
in response to determining that the one medical condition does require treatment by a physician, recommending a particular physician to the user or scheduling an appointment with a physician identified in a medical profile for the user.

6. The method of claim 1, wherein the one or more medical conditions are determined in view of a medical profile of the user.

7. The method of claim 6, further comprising at least one of:
before the expert knowledge graph model is used to determine one or more medical conditions, filtering the expert keywords based on the medical profile of the user; or
after the expert knowledge graph model is used to determine one or more medical conditions, filtering the medical conditions based on the medical profile of the user.

8. A non-transitory computer-medium having stored thereon executable instructions that, when executed by at least one hardware processor, perform operations for automating medical diagnosis comprising:
receiving from an electronic device of a user, a user medical query comprising one or more symptoms;
parsing the user medical query into one or more keywords representing the symptoms;
correlating the one or more keywords to one or more expert keywords using a correlation graph model;
determining one or more medical conditions based upon the one or more expert keywords using an expert knowledge graph model; and
transmitting a response to the electronic device based on the one or more medical conditions.

9. The medium of claim 8, wherein the correlation graph model is dynamically updated, and the expert knowledge graph model is static.

10. The medium of claim 8, wherein the operations further comprise filtering the one or more keywords by limiting the one or more keywords to only those keywords that meet a threshold correlation to an expert keyword.

11. The medium of claim 8, wherein the operations further comprise:
in response to determining that more than one medical condition is determined using the expert knowledge graph model:
using the expert knowledge graph model to determine one or more additional symptoms that will reduce the number of medical conditions determined by the expert knowledge graph model;
prompting the user to answer whether the user has any of the one or more additional symptoms.

12. The medium of claim 8, wherein the operations further comprise:
in response to determining that one medical condition is determined by the expert knowledge graph model:
determining whether the one medical condition requires a treatment by a physician;
in response to determining that the one medical condition does not require treatment by a physician, generating a self-care recommendation for the user;
in response to determining that the one medical condition does require treatment by a physician, recommending a particular physician to the user or scheduling an appointment with a physician identified in a medical profile for the user.

13. The medium of claim 8, wherein the one or more medical conditions are determined in view of a medical profile of the user.

14. The medium of claim 13, wherein the operations further comprise at least one of:
before the expert knowledge graph model is used to determine one or more medical conditions, filtering the expert keywords based on the medical profile of the user; or
after the expert knowledge graph model is used to determine one or more medical conditions, filtering the medical conditions based on the medical profile of the user.

15. A system comprising at least one hardware processor coupled to a memory, the memory having stored thereon executable instructions that, when executed by the at least one hardware processor, perform operations for automating medical diagnosis comprising:
receiving from an electronic device of a user, a user medical query comprising one or more symptoms;
parsing the user medical query into one or more keywords representing the symptoms;
correlating the one or more keywords to one or more expert keywords using a correlation graph model;
determining one or more medical conditions based upon the one or more expert keywords using an expert knowledge graph model; and
transmitting a response to the electronic device based on the one or more medical conditions.

16. The system of claim 15, wherein the correlation graph model is dynamically updated, and the expert knowledge graph model is static.

17. The system of claim 15, wherein the operations further comprise filtering the one or more keywords by limiting the one or more keywords to only those keywords that meet a threshold correlation to an expert keyword.

18. The system of claim 15, wherein the operations further comprise:
in response to determining that more than one medical condition is determined using the expert knowledge graph model:
using the expert knowledge graph model to determine one or more additional symptoms that will reduce the number of medical conditions determined by the expert knowledge graph model;
prompting the user to answer whether the user has any of the one or more additional symptoms.

19. The system of claim 15, wherein the operations further comprise:
in response to determining that one medical condition is determined by the expert knowledge graph model:
determining whether the one medical condition requires a treatment by a physician;
in response to determining that the one medical condition does not require treatment by a physician, generating a self-care recommendation for the user;
in response to determining that the one medical condition does require treatment by a physician, recommending a particular physician to the user or scheduling an appointment with a physician identified in a medical profile for the user.

20. The system of claim 15, wherein the one or more medical conditions are determined in view of a medical profile of the user.

21. The system of claim 20, wherein the operations further comprise at least one of:
before the expert knowledge graph model is used to determine one or more medical conditions, filtering the expert keywords based on the medical profile of the user; or
after the expert knowledge graph model is used to determine one or more medical conditions, filtering the medical conditions based on the medical profile of the user.
